(19) United States
(12) Patent Application Publication
(10) Pub. No.: US 2020/0159197 A1
(43) Pub. Date: May 21, 2020

(54) MANUFACTURING CONDITION SPECIFYING SYSTEM AND METHOD

(71) Applicant: HITACHI, LTD., Tokyo (JP)

(72) Inventors: Kazuki HORIWAKI, Tokyo (JP); Kei IMAZAWA, Tokyo (JP)

(21) Appl. No.: 16/571,471

(22) Filed: Sep. 16, 2019

(30) Foreign Application Priority Data
Nov. 21, 2018 (JP) 2018-218491

(51) Int. Cl. G05B 19/418; G06N 3/08

(52) U.S. Cl. CPC G05B 19/41885; G05B 19/4184; G06N 3/08; G05B 19/41875

(57) ABSTRACT

Specifying a suitable manufacturing condition and maintaining product quality is provided when there is a manufacturing state change. A computer in a manufacturing condition specifying system uses manufacturing condition data and quality data at a plurality of time points from a manufacturing flow to build models for each manufacturing state change in each manufacturing process of the flow. The computer uses the model and a quality target value to calculate a predicted value of a manufacturing condition at a next time point as first data based on a first learning model. The computer uses the model as well as the manufacturing condition data and quality data at the current time point to predict quality data at a next time point and calculate a quality error, and uses the first data and the quality error to specify manufacturing condition data at the next time point based on a learning model.

### CROSS-REFERENCE TO RELATED APPLICATION

The present application claims priority from Japanese application JP 2018-218491, filed on Nov. 21, 2018, the contents of which is hereby incorporated by reference into this application.

### TECHNICAL FIELD

The present invention relates to a technique such as information processing, and relates to a technique of controlling or specifying a manufacturing condition in a manufacturing flow.

### BACKGROUND ART

In a manufacturing system in the manufacturing industry, quality of a manufactured product may vary depending on setting or control of a manufacturing condition in a manufacturing flow. Therefore, an information processing system or the like (sometimes referred to as a manufacturing condition specifying system) for specifying a suitable manufacturing condition is developed so as to maintain or improve the quality of the manufactured product.

PTL 1, PTL 2, and PTL 3 are listed as related-art examples of specifying a manufacturing condition. PTL 1 discloses a method of managing product quality or the like in which a probability model is built from a past manufacturing condition and a manufacturing condition that matches a target value is calculated. PTL 2 discloses a method of predicting an output value or the like in which a plurality of predicted values are output from past performance data. PTL 3 discloses a machine learning system or the like in which a non-parametric expressed class set is generated, in other words, the number of dimensions is reduced, when the number of inputs to be input at the time of using a model is larger than a predetermined number.

### PRIOR ART LITERATURE

### Patent Literature

PTL 1: JP-A-2013-84057

PTL 2: JP-A-2011-39763

PTL 3: JP-A-2013-205890

### SUMMARY OF INVENTION

### Technical Problem

The manufacturing state changes every day in a site of the manufacturing industry. The manufacturing state change is, for example, a change in a state of a manufacturing device in a manufacturing process. A state of parameters such as a current, voltage, temperature, pressure, or the like may change in a manufacturing process, for example, by continuing an operation in a manufacturing flow. For example, a state of the manufacturing device may change when a maintenance operation is performed on the manufacturing device.

In order to maintain or improve product quality, it is effective to specify a suitable manufacturing condition according to the manufacturing state change and set the manufacturing condition in the manufacturing flow for operation. The product quality is a predetermined evaluation index value, and is obtained, for example, as a value of an inspection result of a quality inspection process, for example, a yield.

A system for predicting a manufacturing condition using a learning model on a computer is listed as a related-art example of a manufacturing condition specifying system. The system builds a model using performance data including a manufacturing condition and quality of a manufacturing flow, and predicts a suitable manufacturing condition based on learning in a predetermined learning model.

However, there is a room for improvement for the manufacturing condition specifying system as a related-art example in terms of specifying the suitable manufacturing condition according to the manufacturing state change. For example, immediately after the manufacturing state change, the number of data obtained from performance of an operation is small, that is, the number of data for advancing the learning in the learning model is small. Therefore, it is difficult to improve prediction accuracy of the model. In order to improve the prediction accuracy of the model, it is necessary to input the number of data of a certain degree or more to the model so as to advance the learning, but it takes time. When the prediction accuracy of the model is low immediately after the manufacturing state change, a suitable manufacturing condition cannot be specified. As a result, the product quality cannot be maintained or improved.

An object of the invention is to provide a technique capable of specifying a suitable manufacturing condition and maintaining or improving product quality even when the manufacturing condition may change in a manufacturing condition specifying system. Other problems, configurations, effects, and the like will be described in the detailed description of the invention.

### Solution to Problem

A representative embodiment of the invention includes the following configurations. A manufacturing condition specifying system according to an embodiment includes a computer that specifies a manufacturing condition in each manufacturing process of a manufacturing flow. The computer uses manufacturing condition data and quality data at a plurality of time points including a current time point from the manufacturing flow to build a model related to the manufacturing condition and quality; at a time of building the model, builds models each being built for a manufacturing state change as a plurality of models in a case of including manufacturing state changes in the manufacturing process of the manufacturing flow; uses the model and a quality target value to calculate, in the model, a predicted value of manufacturing condition data at a next time point as first data based on learning in a first learning model; uses the model as well as the manufacturing condition data and quality data at the current time point to predict quality data at a next time point and calculate a quality error between the quality data at the next time point and the quality data at the current time point; uses the first data and the quality error to specify manufacturing condition data at the next time point based on learning in a learning model; and stores and outputs information including the specified manufacturing condition data at the next time point.

### Advantageous Effect

According to the representative embodiment of the invention, even when the manufacturing condition may change in the manufacturing condition specifying system, a suitable manufacturing condition can be specified, and the product quality can be maintained or improved.

### BRIEF DESCRIPTION OF DRAWINGS

FIG. 1 is a diagram showing a configuration of a computer of a manufacturing condition specifying system according to an embodiment of the invention.

FIG. 2 is a diagram showing an example of configurations of a manufacturing flow and a model according to the embodiment.

FIG. 3 is a flowchart showing a processing flow of a manufacturing condition specifying processing in the manufacturing condition specifying system according to the embodiment.

FIG. 4 is a diagram showing an example of configurations of functional blocks and data in the manufacturing condition specifying system according to the embodiment.

FIG. 5 is a flowchart showing a processing flow of a subspace conversion processing in the manufacturing condition specifying system according to the embodiment.

FIG. 6 is a diagram showing an example of a model building screen in the embodiment.

FIG. 7 is a diagram showing an example of a screen of manufacturing condition data and subspace data in the embodiment.

FIG. 8 is a diagram showing an example of a screen of quality data in the embodiment.

FIG. 9 is a diagram showing an example of a screen of specified manufacturing condition data in the embodiment.

FIG. 10 is a diagram showing an example of a screen of model building setting in the embodiment.

FIG. 11 is a diagram showing an example of processing in step S11 in the embodiment.

FIG. 12 is a diagram showing examples of processing in step S13 and processing in step S14 in the embodiment.

FIG. 13 is a diagram showing an example of processing in step S14 in the embodiment.

FIG. 14 is a diagram showing an example of a configuration of manufacturing condition data in the embodiment.

FIG. 15 is a diagram showing an example of a configuration of quality data in the embodiment.

FIG. 16 is a diagram showing an example of a configuration of causality model data in the embodiment.

FIG. 17 is a diagram showing an example of a configuration of first learning model data in the embodiment.

FIG. 18 is a diagram showing an example of a configuration of subspace data in the embodiment.

FIG. 19 is a diagram showing an example of a configuration of third learning model data in the embodiment.

FIG. 20 is a diagram showing an example of model building based on manufacturing condition data corresponding to whether there is a change in a manufacturing state.

### DESCRIPTION OF EMBODIMENTS

Hereinafter, embodiments of the invention will be described in detail with reference to the drawings. It should be noted that in all the drawings for describing the embodiments, the same components are denoted by the same reference numerals in principle, and a repetitive description thereof will be omitted.

### EMBODIMENT

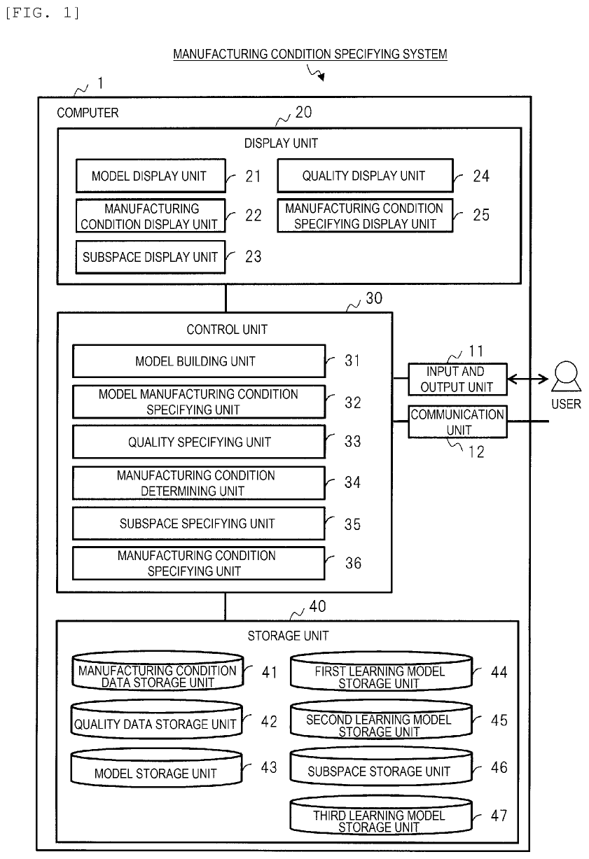

A manufacturing condition specifying system according to an embodiment of the invention will be described with reference to FIGS. 1 to 20. The manufacturing condition specifying system according to the embodiment is a system that specifies a suitable manufacturing condition according to a manufacturing state change in a target manufacturing flow by using a model and learning on a computer. A manufacturing condition specifying method according to the embodiment is a method including steps to be executed in the manufacturing condition specifying system according to the embodiment.

The manufacturing condition specifying system according to the embodiment builds one or more models related to a manufacturing condition and quality using manufacturing condition data and quality data at a plurality of time points including a current time point, which includes a manufacturing state change in the manufacturing flow, based on performance of an operation. The system uses manufacturing condition data and models up to the current time point to calculate a predicted value of manufacturing condition data at a next time point based on learning in a learning model. The system further uses quality data and the models up to the current time point to calculate a predicted value of quality at a next time point and calculate a quality error between the quality at the current time point and the quality at the next time point. The system uses the above data to specify suitable manufacturing condition data at the next time point based on the learning in the learning model. Accordingly, the suitable manufacturing condition data at the next time point after the manufacturing state change is obtained. The system stores and outputs information such as specified manufacturing condition data. The manufacturing condition data is reflected, that is, set in the manufacturing flow and the operation is executed. Accordingly, product quality after the manufacturing state change can be maintained or improved.

Further, the manufacturing condition specifying system according to the embodiment converts the manufacturing condition data obtained using the models into a subspace so as to reduce the number of dimensions. The conversion reduces the number of dimensions of data without reducing an amount of information of the model and enables subsequent learning. The system uses subspace data obtained after the conversion to specify a suitable manufacturing condition based on the learning model. At the time of specifying processing, data having a small number of dimensions can be regarded as an input, and the processing can be executed effectively.

### [Manufacturing Condition Specifying System]

FIG. 1 shows a configuration of the manufacturing condition specifying system according to the embodiment. The manufacturing condition system according to the embodiment is implemented by a computer 1. The computer 1 can be configured with a general PC or the like. In addition, the computer 1 may be configured with a server device or the like on a communication network. The computer 1 implements a characteristic function by a software program processing. A user operates the computer 1 to execute an operation such as specifying a manufacturing condition. The user is, for example, a person such as a System Engineer (SE) having expert knowledge about a manufacturing system or machine learning.

The computer 1 includes an input and output unit 11, a communication unit 12, a display unit 20, a control unit 30, a storage unit 40, and the like. These units are connected by a bus or the like (not shown). The input and output unit 11 is connected with an input device (for example, a keyboard or a mouse), a display device (for example, a liquid crystal display, a touch panel), or other output devices (for example, a printer) (not shown), and receives an operation of the user. The communication unit 12 includes a communication interface device for a communication network such as a LAN outside the computer 1, and executes a communication processing between an external server device and a manufacturing system device. The communication unit 12 acquires data such as manufacturing condition data or information from an external device under the control of the control unit 30.

The display unit 20 includes a screen (corresponding screen data or the like) in the manufacturing condition specifying system, and displays the screen on a display screen of a display device. Various types of information such as a manufacturing condition, quality, and a model are displayed on various types of screens which will be described later. The screen functions as a Graphical User Interface (GUI) of the manufacturing condition specifying system. GUI components such as a window, a scroll bar, a list box, a button, and the like are displayed on the screen, and a user operation can be executed through the GUI components.

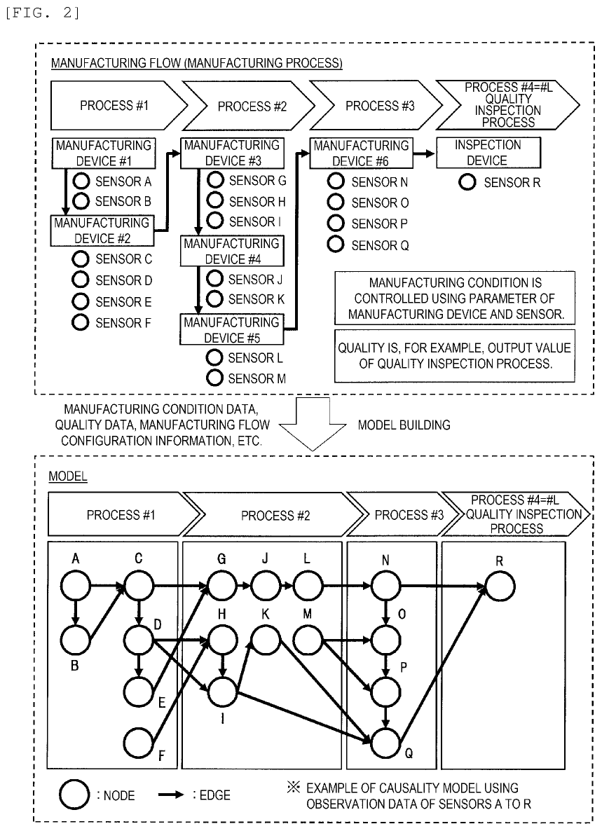

The user or the computer 1 acquires necessary data such as manufacturing condition data or quality data from each manufacturing processing in a manufacturing flow (will be described in FIG. 2) of a target manufacturing system. A method of acquiring the necessary data may be any method, and is not particularly limited. In the embodiment, in particular, the computer 1 is connected to the target manufacturing system through a communication network such as a LAN. Then, the computer 1 acquires manufacturing condition data, quality data, manufacturing flow configuration information, and the like from a manufacturing device, a sensor, a control device, or the like of the manufacturing system via communication. Accordingly, the computer 1 can monitor the state of the manufacturing flow or the performance of an operation. The computer 1 can use a file or a signal output from, for example, a manufacturing device or a sensor as data.

The user inputs necessary data to the computer 1, and the computer 1 executes a calculation. The computer 1 specifies a suitable manufacturing condition in a target manufacturing flow by a calculation using a model built by using the input data. The user checks the suitable manufacturing condition obtained by the computer 1 on the screen and reflects the suitable manufacturing condition in a manufacturing flow of the target manufacturing system. That is, a parameter value used for control corresponding to the manufacturing condition is set in a manufacturing device in each manufacturing process of the manufacturing flow. The computer 1 may be configured to transmit and set the manufacturing condition or the like to the manufacturing device in each manufacturing process of the manufacturing flow through communication.

The control unit 30 is, in other words, a processor, and includes known elements such as a CPU, a RAM, and a ROM. The control unit 30 has the following configurations as a main processing unit implemented based on program processing. That is, the control unit 30 includes a model building unit 31, a model manufacturing condition specifying unit 32, a quality specifying unit 33, a manufacturing condition determining unit 34, a subspace specifying unit 35, and a manufacturing condition specifying unit 36. The control unit 30 stores various types of data related to the manufacturing condition specifying in the storage unit 40 and manages the information.

The storage unit 40 stores various types of data and information related to the manufacturing condition specifying. The storage unit 40 may be configured with a nonvolatile memory, a storage device, or the like, and may be configured with an external DB server or the like. The storage unit 40 includes a manufacturing condition data storage unit 41, a quality data storage unit 42, a model storage unit 43, a first learning model storage unit 44, a second learning model storage unit 45, a subspace storage unit 46, and a third learning model storage unit 47. The manufacturing condition data storage unit 41 stores manufacturing condition data acquired from the manufacturing flow and manufacturing condition data specified by the computer 1. The quality data storage unit 42 stores quality data and the like acquired from the manufacturing flow. The model storage unit 43 stores data of a model that is built by the computer 1 and related to the manufacturing condition and quality. The first learning model storage unit 44 stores data of a first learning model to be described later. The second learning model storage unit 45 stores data of a second learning model to be described later. The subspace storage unit 46 stores subspace data to be described later. The third learning model storage unit 47 stores data of a third learning model to be described later.

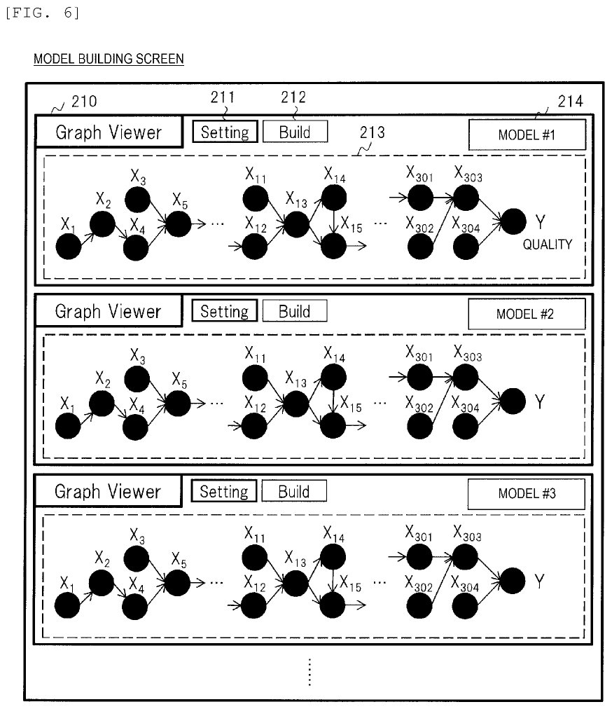

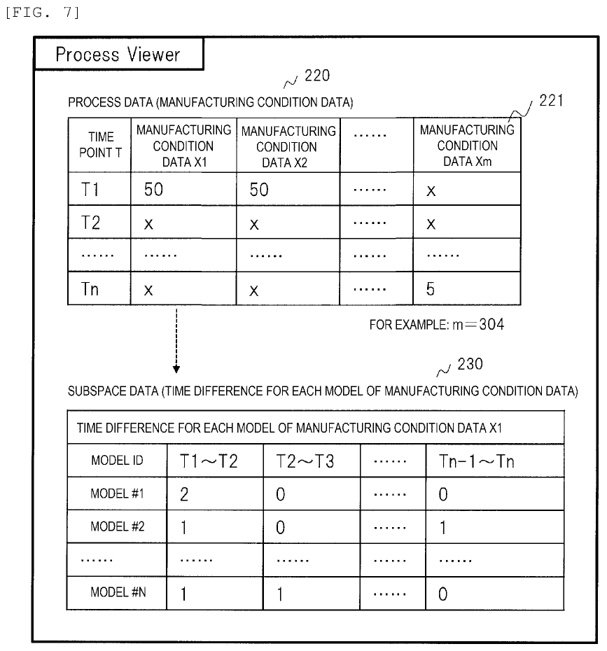

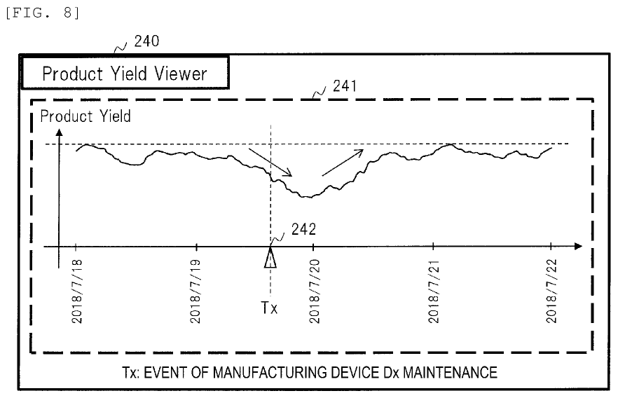

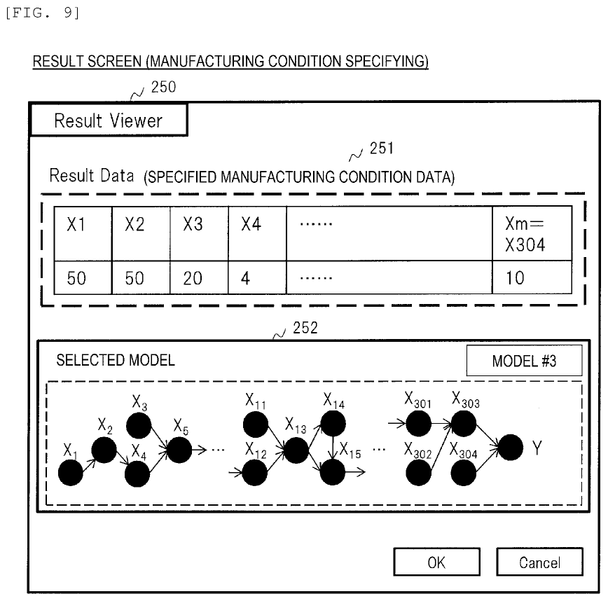

The display unit 20 executes processing of displaying various types of data or information on a screen of a display device based on processing of the control unit 30. The display unit 20 includes a model display unit 21, a manufacturing condition display unit 22, a subspace display unit 23, a quality display unit 24, and a manufacturing condition specifying display unit 25. The model display unit 21 graphically displays a built model on a screen (to be described in FIG. 6). The manufacturing condition display unit 22 displays manufacturing condition data on a screen (to be described in FIG. 7). The subspace display unit 23 displays subspace data on the screen (to be described in FIG. 7). The quality display unit 24 displays a graph of a product yield as quality on a screen (to be described in FIG. 8). The manufacturing condition specifying display unit 25 displays suitable manufacturing condition data specified by the computer 1 on a screen (to be described in FIG. 9).

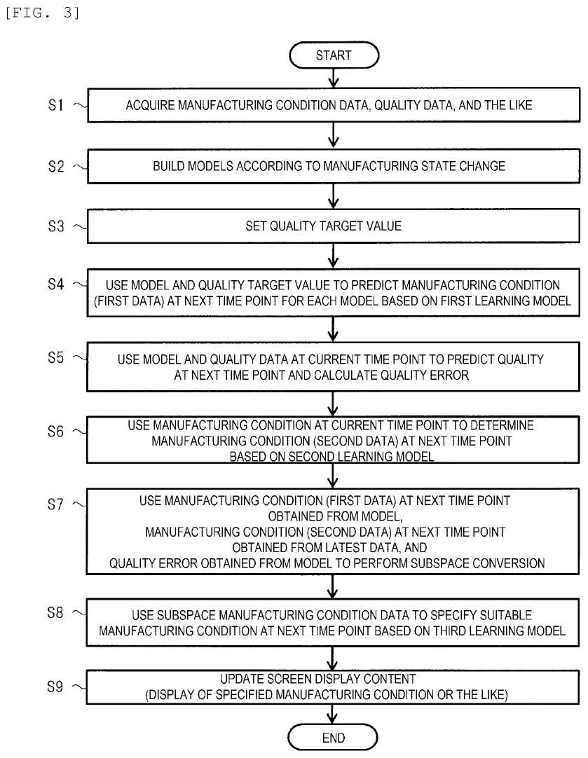

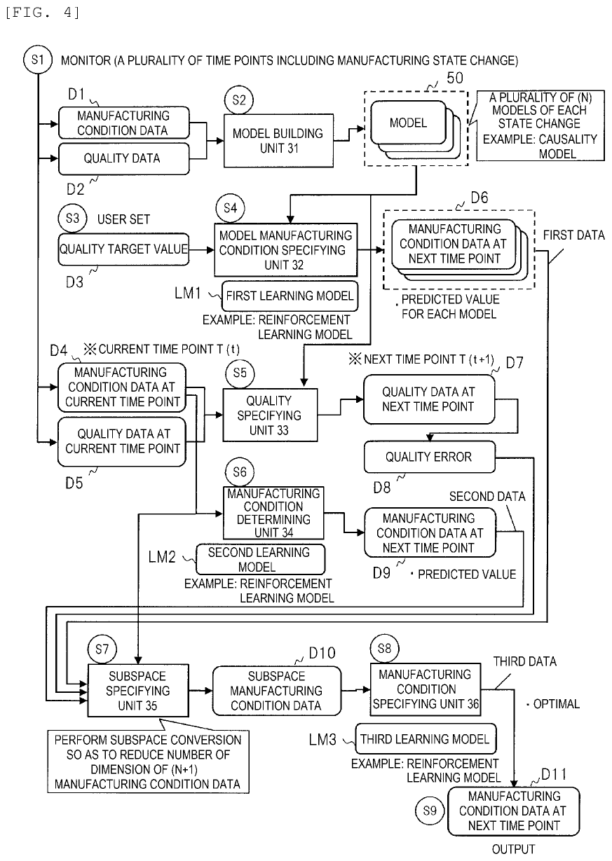

The model building unit 31 executes processing (step S2 to be described in FIGS. 3 and 4) of building one or more models (models 50 to be described in FIG. 4) using the manufacturing condition data in the manufacturing condition storage unit 41 and the quality data in the quality data storage unit 42. It should be noted that the model building includes updating a model that is already built.

The model manufacturing condition specifying unit 32 executes processing (step S4 to be described in FIGS. 3 and 4) of specifying a predicted value of a manufacturing condition at a next time point based on learning in a predetermined learning model (referred to as a first learning model) using a model obtained by the model building unit 31 and a quality target value.

The manufacturing condition determining unit 34 executes processing (step S6 to be described in FIGS. 3 and 4) of determining a predicted value of a manufacturing condition at the next time point based on learning in a predetermined learning model (referred to as a second learning model) using manufacturing condition data at the latest current time point obtained from actual manufacture without using the above-mentioned model.

The quality specifying unit 33 executes processing (step S5 to be described in FIGS. 3 and 4) of predicting quality at the next time point using the model obtained by the model building unit 31 and the manufacturing condition data at the current time point, and calculating a quality error which is an error between the quality at the next time point and the quality at the current time point.

The subspace specifying unit 35 uses data including the manufacturing condition data (first data) at the next time point obtained from the model manufacturing condition specifying unit 32, the manufacturing condition data (second data) at the next time point obtained from the manufacturing condition determining unit 34, and the quality error obtained from the quality specifying unit 33 as input data. The subspace specifying unit 35 executes processing (step S7 to be described in FIGS. 3 and 4) of converting the manufacturing condition data of the input data into a subspace which is a space different from an original space. In other words, subspace conversion processing which is the above-mentioned processing is processing of projecting the input data into a low-dimensional space in which the number of dimensions is reduced. The subspace conversion processing reduces the number of dimensions of the input manufacturing condition data so as to match an input format of manufacturing condition specifying processing in the manufacturing condition specifying unit 36. The subspace conversion processing reduces the number of dimensions of the input to match the number of dimensions of an input of the third learning model to be described later. A result of the subspace conversion processing is to obtain subspace manufacturing condition data which is subspace data.

The manufacturing condition specifying unit 36 finally executes processing (step S8 to be described in FIGS. 3 and 4) of specifying an optimal manufacturing condition at the next time point based on learning in a predetermined learning model (referred to as a third learning model) by using the subspace manufacturing condition data obtained from the subspace specifying unit 35 as an input.

### [Manufacturing Flow and Model]

FIG. 2 shows an example of configurations of the manufacturing flow and the model (models 50 in FIG. 4). A schema of the manufacturing flow is shown on an upper side of FIG. 2, and a schema of a causality model as an example of a model built based on the manufacturing flow is shown on a lower side. The manufacturing flow includes a plurality of processes (manufacturing processes) from an upstream to a downstream, and includes four processes of processes #1, #2, #3, and #4=#L in the present example. The last process #L is a quality inspection process in the present example. One or more manufacturing devices and one or more sensors associated therewith are provided in each process. In the quality inspection process, an inspection device and a sensor are provided, and quality data is output as inspection result data. For example, manufacturing devices #1 and #2 are provided for the process #1. The manufacturing device #1 controls and executes manufacturing in the process #1 according to a set manufacturing condition. The manufacturing device #1 includes, for example, sensors A and B. The sensor A detects a predetermined parameter value and outputs the detected predetermined parameter value as observation data during manufacturing executed by the manufacturing device #1 in the process #1. Similarly, a manufacturing device and a sensor are provided in each process, and the manufacturing devices and the sensors are connected according to a process order or the like. Such a manufacturing flow configuration is managed as manufacturing flow configuration information in the manufacturing system.

Manufacturing condition data is associated with each process. The manufacturing condition data (corresponding data item) is a parameter value for controlling states of the manufacturing device and the sensor. Examples of general parameters include a current, voltage, temperature, pressure or the like. The computer 1 in the manufacturing condition specifying system according to the embodiment acquires manufacturing condition data, quality data, manufacturing flow configuration information, or the like from the manufacturing flow of the manufacturing system. The user or the computer 1 can acquire the manufacturing condition data or the like from the manufacturing device in each process or a control device. The manufacturing condition specifying system can acquire, as monitoring data of performance of an operation, the manufacturing condition data and the quality data at each time point in time series including a manufacturing state change in the manufacturing flow.

In the embodiment, the quality inspection process as a last process of the manufacturing flow is included. The quality data is obtained from the quality inspection process, and a method is applied to associate the quality data and the manufacturing condition data. The invention is not limited thereto, and a method can be applied similarly, for example, even in a case where a quality inspection flow exists independently of the manufacturing flow.

The manufacturing condition specifying system according to the embodiment builds the causality model based on the manufacturing condition data and the quality data acquired from the above-mentioned manufacturing flow. The causality model on a lower side of FIG. 2 can be expressed by a network structure. That is, the model can be expressed by a connection between a node shown by a circle and an edge shown by an arrow. Each manufacturing condition data can be expressed as a node. The edge represents a direction of the causality. The present example shows a case of the causality that uses observation data of sensors A, B . . . R as the manufacturing condition data. For example, in a portion corresponding to the process #1, a node A corresponding to the observation data of the sensor A is connected to a node B and a node C. The node B is connected to the node C. The node C is connected to a node D and a node G.

The manufacturing condition specifying system according to the embodiment specifies suitable manufacturing condition data based on a built model, and stores and outputs the specified manufacturing condition data. By referring to the manufacturing flow configuration information or the like, the user or the computer 1 can check a corresponding relationship as to whether the specified manufacturing condition data is associated with a corresponding manufacturing device and sensor in a corresponding manufacturing process of the manufacturing flow. For example, the user can output information of associating the manufacturing condition data specified by the computer 1 with a manufacturing flow configuration to the manufacturing system or a person in the manufacturing site. Alternatively, the computer 1 can transmit, to the manufacturing system, information of associating the specified manufacturing condition data with the manufacturing flow configuration, and set the information in each manufacturing device or the like.

### [Processing Flow and Functional Block Configuration]

FIG. 3 shows a processing flow including the manufacturing condition specifying processing executed by the control unit 30 of the computer 1 in the manufacturing condition specifying system according to the embodiment. The processing flow in FIG. 3 includes steps S1 to S9. FIG. 4 shows a configuration of data and functional blocks of the control unit 30 corresponding to the steps in FIG. 3. Hereinafter, the processing will be described in order of steps with reference to FIGS. 3 and 4.

(S1) First, in step S1, the control unit 30 acquires, as monitoring data of performance of the operation, the manufacturing condition data from each manufacturing process in the manufacturing flow and the quality data from the quality inspection process. The control unit 30 stores the acquired manufacturing condition data in the manufacturing condition data storage unit 41, and stores the acquired quality data in the quality data storage unit 42. The model building unit 31 refers to acquired manufacturing condition data D1 and quality data D2 from the storage unit 40.

The data (D1 and D2) is data acquired at each time point in time series (corresponding acquisition time point) including time points before and after a manufacturing state change. Time point T is used as a time point for explanation. Manufacturing condition data and quality data obtained at a certain time point T may be expressed as the manufacturing condition data at the time point T and the quality data at the time point T. A current time point may be expressed as a time point (t) and a next time point may be expressed as a time point (t+1).

(S2) Next, in step S2, the model building unit 31 builds the models 50 using the manufacturing condition data and the quality data that is obtained at a past time point and stored in the storage unit 40, in addition to using the manufacturing condition data and the quality data at the latest time point T obtained in step S1. The models 50 include one or more models. In the embodiment, the models 50 are a plurality of (N) models when there is a manufacturing state change. The number of models is set as N. In the embodiment, the causality model as shown in FIG. 2 is used for all of the plurality of (N) models.

The model building unit 31 builds each of the models 50 based on the manufacturing condition data D1 and the quality data D2 at each time point according to the manufacturing state change. The model building unit 31 builds a plurality of models (for example, FIG. 20 to be described later) by dividing the manufacturing state change at each time point at the time of the model building. At the time of the model building, for example, when there is an event of a manufacturing state change in a certain manufacturing process, the model building unit 31 divides the manufacturing condition data by a time point of the event. Then, according to a plurality of data sections obtained by dividing, the model building unit 31 builds a model for each section. For example, when there is one event of a manufacturing state change, a model at a time period before the manufacturing state change and a model at a time period after the manufacturing state change are built.

It should be noted that the models 50 are not limited to the causality model, and other types of models can be applied. In addition, models of a plurality of types may be mixed in the plurality of (N) models.

The model building unit 31 stores data of the built models 50 in the model storage unit 43. The model display unit 21 displays information of the built models 50 on a model building screen in FIG. 6.

(S3) In step S3, the control unit 30 sets a quality target value based on a user operation. For example, the display unit 20 provides a setting screen related to quality. A quality target value setting field may be provided in a quality screen in FIG. 8 to be described. On the setting screen, the user sets the quality target value, for example, a target value of a product yield. The control unit 30 stores setting information including a quality target value D3 in the quality data storage unit 42. The control unit 30 may refer to setting information of a preset quality target value if present.

(S4) In step S4, the model manufacturing condition specifying unit 32 uses the models 50 built in S2 to specify, for each model when there are a plurality of models, a predicted value of manufacturing condition data at a next time point (t+1) with respect to a current time point (t). In FIG. 4, based on learning in a first learning model LM1, the model manufacturing condition specifying unit 32 calculates, as a predicted value for each model, manufacturing condition data D6 at a next time point from the models 50 and the quality target value D3. The manufacturing condition data D6 is the first data.

In the processing of S4, the model manufacturing condition specifying unit 32 specifies a manufacturing condition under which quality is good with respect to the quality target value D3 for each of the models 50. The model manufacturing condition specifying unit 32 stores the obtained manufacturing condition data D6 in the storage unit 40. The model manufacturing condition specifying unit 32 stores, in the first learning model storage unit 45, data of the used first learning model including updating. In the embodiment, the first learning model is, for example, a reinforcement learning model.

(S5) In step S5, the quality specifying unit 33 uses the models 50 in S2 to predict quality data D7 at the next time point (t+1) from manufacturing condition data D4 and quality data D5 at the current time point (t). Then, the quality specifying unit 33 compares the predicted quality data D7 at the next time point with the quality data D5 at the current time point (t), and calculates a quality error D8 which is an error between the quality data D7 and the quality data D6. The manufacturing condition data D4 and the quality data D5 at the current time point (t) can use data stored in the quality data storage unit 42. The quality specifying unit 33 stores the data (D7 and D8) calculated in S5 in the quality data storage unit 42.

(S6) In step S6, based on learning in a second learning model LM2, the manufacturing condition determining unit 34 determines a predicted value of manufacturing condition data D9 at the next time point (t+1) from the manufacturing condition data D4 at the latest current time point (t) in performance without using the models 50. The manufacturing condition data D9 is the second data. The manufacturing condition determining unit 34 stores the obtained manufacturing condition data D9 in the storage unit 40. The manufacturing condition determining unit 34 stores, in the second learning model storage unit 45, data of the second learning model LM2 including updating. In the embodiment, similar to the first learning model LM1, the second learning model LM2 is, for example, a reinforcement learning model.

In the embodiment, both the manufacturing condition data D6 which is the first data and the manufacturing condition data D9 which is the second data are used as input data of processing in S7.

(S7) In step S7, data including the manufacturing condition data D6 at the next time point which is the first data obtained in S4, the manufacturing condition data D9 at the next time point which is the second data obtained in S6, the quality error D8 obtained in S5, and the manufacturing condition data D4 at the current time point is input into the subspace specifying unit 35. The subspace specifying unit 35 executes subspace conversion processing in which the manufacturing condition data of the input data including the first data and the second data is converted into subspace data. The number of the manufacturing condition data D6 at the next time point which is the first data obtained in S4 is N corresponding to the number N of the models 50. The number of the manufacturing condition data D9 at the next time point which is the second data obtained in S6 is one. That is, the number of the manufacturing condition data of the input in S7 is (N+1). The subspace conversion processing in S7 is processing of projecting the (N+1) manufacturing condition data into a subspace (in other words, a low-dimensional space) which is a space different from the original space.

The conversion in S7 is a conversion to reduce the number of dimensions of the input data so as to match the number of dimensions of an input format in manufacturing condition specifying processing in S8. In other words, the number of dimensions of the input format of a third learning model LM3 in the manufacturing condition specifying processing in S8 matches the number of dimensions of the subspace data obtained in S7. The subspace data obtained in S7 is data projected to the subspace, and is data whose number of dimensions of parameter is reduced. When the number of dimensions of the (N+1) manufacturing condition data is set as DN1 and the number of dimensions of the subspace data is DN2, DN1>DN2. The number of dimensions DN2 matches the number of dimensions of the input of the third learning model LM3 in the manufacturing condition specifying processing in S8. Details of the processing in S7 will be described later.

The subspace specifying unit 35 obtains subspace manufacturing condition data D10 as the subspace data which is output data. The subspace specifying unit 35 stores the obtained subspace data in the subspace storage unit 46. The subspace display unit 23 displays the subspace data in a subspace data area 230 on a screen in FIG. 7.

(S8) In step S8, the manufacturing condition specifying unit 36 uses the subspace manufacturing condition data D10 obtained in S7 to specify optimal manufacturing condition data D11 at the next time point (t+1) based on the learning in the third learning model LM3. The manufacturing condition data D11 is third data. In the processing, the manufacturing condition specifying unit 36 finally specifies optimal manufacturing condition data to be applied to the manufacturing flow from the (N+1) manufacturing condition data in the subspace data. In the processing, the manufacturing condition specifying unit 36 uses past manufacturing condition data and the quality error D8 to build the third learning model LM3. In the embodiment, a reinforcement learning model is used as the third learning model LM3. The manufacturing condition specifying unit 36 stores the specified manufacturing condition data D11 at the next time point (t+1) in the manufacturing condition data storage unit 41. The manufacturing condition specifying unit 36 stores, in the third learning model storage unit 47, data of the third learning model LM3 including updating.

(S9) In step S9, the display unit 20 displays, on a screen, various types of data or information such as the manufacturing condition data, the quality data, and the models, which are obtained as results of the above processing, so as to update screen display content. For example, the manufacturing condition specifying display unit 25 displays information of the manufacturing condition data D11 at the next time point (t+1) specified in S8 in a manufacturing condition data area 251 on a result screen in FIG. 9. Corresponding to the specified manufacturing condition data D11, the manufacturing condition specifying display unit 25 displays information of a model selected from the models 50 in a model area 252 on the result screen in FIG. 9. The user can see the result screen and check a suitable manufacturing condition and a model used at the time of specifying the optimal manufacturing condition.

The specified optimal manufacturing condition data D11 can be reflected in the manufacturing flow of the manufacturing system according to an operation of the user. For example, the manufacturing condition data D11 can be set to the manufacturing flow by pressing an OK button on the result screen in FIG. 9. Thereafter, an operation after the next time point is to be executed. The processing flow in FIG. 3 is similarly repeated for each time point. Accordingly, learning in each learning model is advanced, and prediction accuracy is gradually improved. It should be noted that screen display of various types of data may be omitted according to a user operation or user setting. The user can designate desired data in a screen to display on the screen, or the data may be output to an external device.

### [Subspace Conversion Processing]

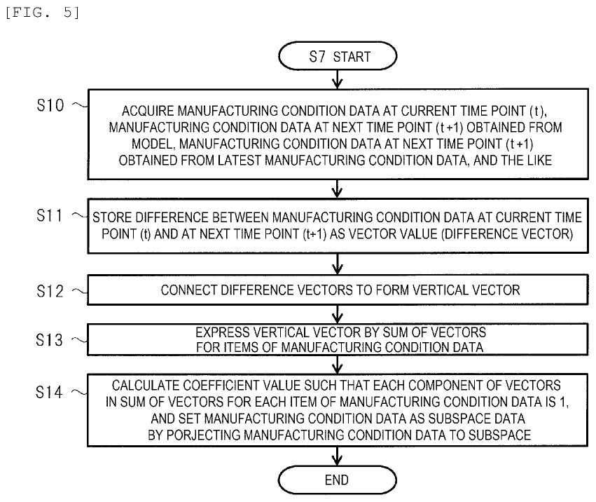

FIG. 5 shows a processing flow of the subspace conversion processing executed by the subspace specifying unit 35 in step S8 in the processing flow of FIG. 3. The processing flow in FIG. 5 includes steps S10 to S15.

(S10) First, in step S10, the subspace specifying unit 35 acquires the manufacturing condition data D4 at the current time point (t) in FIG. 4. The subspace specifying unit 35 acquires the first data which is the N manufacturing condition data D6 at the next time point (t+1) obtained from the models 50 in S4. The subspace specifying unit 35 acquires the second data which is the one manufacturing condition data D9 at the next time point (t+1) obtained from the latest manufacturing condition data D4 in S6. The subspace specifying unit 35 acquires the quality error D8 obtained in S5.

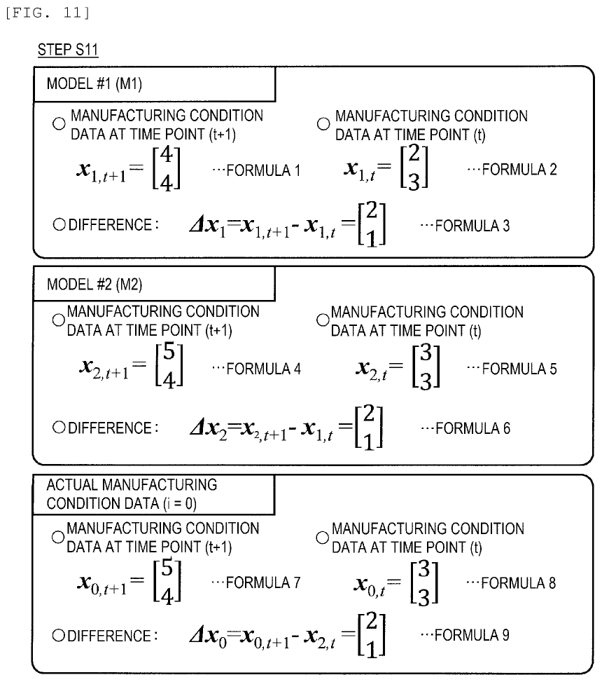

(S11) In step S11, the subspace specifying unit 35 calculates a difference between the manufacturing condition data at the current time point (t) and the manufacturing condition data at the next time point (t+1) from the manufacturing condition data (D6 and D9) obtained in S10, and keeps the difference as a vector value (in other words, a difference vector). Details of S11 will be described in FIG. 11 to be described later.

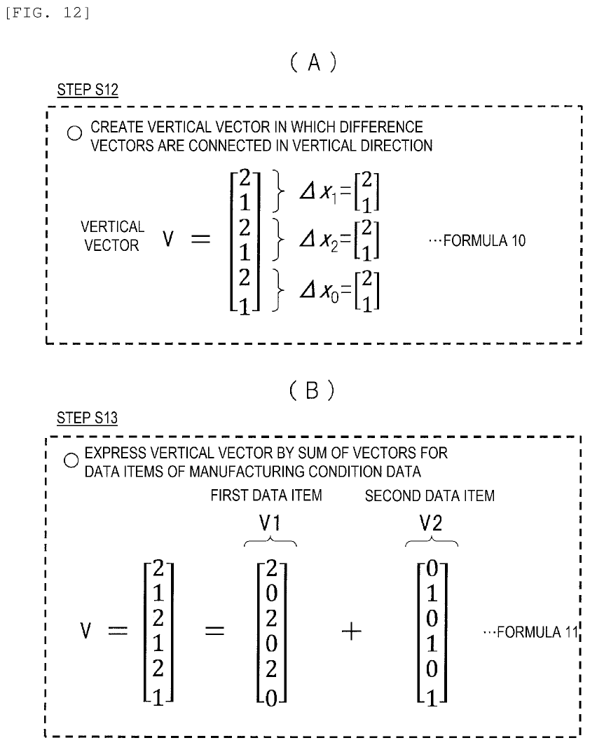

(S12) In step S12, the subspace specifying unit 35 connects the vector values obtained in S11 to form a vertical vector as shown FIG. 12(A) to be described later.

(S13) In step S13, the subspace specifying unit 35 expresses the vertical vector obtained in S12 by a sum of vectors for items of the manufacturing condition data, as shown in FIG. 12(B) to be described later.

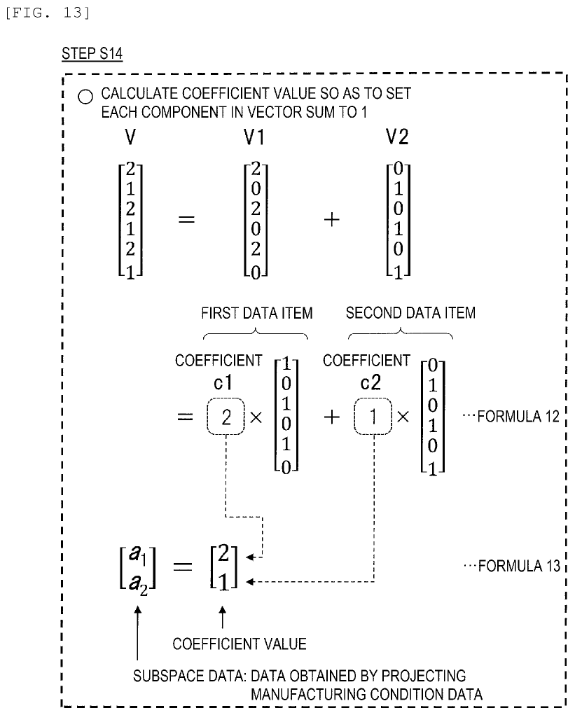

(S14) In step S14, the subspace specifying unit 35 calculates a coefficient value of vectors such that each component of a vector decomposed in the sum of the vectors obtained in S13 is 1. Details of S14 will be shown in FIG. 13 to be described later. The subspace specifying unit 35 takes the obtained coefficient value of the vector as data obtained by projecting the manufacturing condition data into the subspace, and sets the data as subspace manufacturing condition data D10. The subspace data is used as an input of the processing in S8.

FIG. 11 shows an example of the processing in step S11. A simple case is shown in the example in which the number of data items of the manufacturing condition data is two, and the number N of the models 50 is 2. The definition and the like are as follows. Each of the models 50 is represented by a model Mi (i=1, 2). In the example, Model #1 is used as a model M1 and Model #2 is used as a model M2. Two time points T corresponding to before and after the manufacturing state change are set to the time point (t) and the time point (t+1). The manufacturing condition data at the time point (t) in the model Mi is set to x_{i, t}. The manufacturing condition data at the time point (t+1) in the model Mi is set to x_{i, t+1}. An equation i=0 (X₀) represents the manufacturing condition data specified from actual manufacturing condition data. A time difference (that is, the difference vector) in each model of the manufacturing condition data is set to Δx. A calculation in an example of a certain data value is as follows.

For the Model #1 (M1), manufacturing condition data t+i at the time point (t+l) is expressed by a formula 1 when the manufacturing condition data is expressed by a matrix of two rows and one column, in other words, by a column vector with the number of dimensions of 2. In the formula 1, a row vector is expressed by x_{1, t+1}=(4, 4), a first data item value is 4, and a second data item value is 4. When being expressed similarly, the manufacturing condition data x_{1, t} at the time point (t) is expressed by a formula 2. In the formula 2, a row vector is expressed by x_{1, t}=(2, 3), a first data item value is 2, and a second data item value is 3. The subspace specifying unit 35 calculates a difference between the manufacturing condition data x_{1, t+1} in the formula 1 and the manufacturing condition data x_{1, t} in the formula 2, and creates a difference vector in a formula 3. In the formula 3, a row vector is expressed by Δx₁=x_{1, t+1}−x_{1, t}=(2, 1).

Similarly, for the Model #2 (M2), manufacturing condition data x_{2, t+1} at the time point (t+1) is expressed by a formula 4 when the manufacturing condition data is expressed by a matrix of two rows and one column, in other words, by a column vector with the number of dimensions of 2. In the formula 4, a row vector is expressed by x_{2, t+1}=(5, 4). The manufacturing condition data x_{2, t} at the time point (t) is expressed by a formula 5. In the formula 5, the row vector is expressed by x_{2, t}=(3, 3). The subspace specifying unit 35 calculates a difference between the manufacturing condition data x_{2, t+1} in the formula 4 and the manufacturing condition data x_{2, t} in the formula 5, and creates a difference vector in a formula 6. In the formula 6, a row vector is expressed by Δx₂=x_{2, t+1}−x_{2, t}=(2, 1).

Under an actual manufacturing condition (i=0), manufacturing condition data x_{0, t+1} at the time point (t+1) is expressed by a formula 7 when the manufacturing condition data is expressed by a matrix of two rows and one column, in other words, by a column vector with the number of dimensions of 2. In the formula 7, a row vector is expressed by x_{0, t+1}=(5, 4). The manufacturing condition data x_{0, t} at the time point (t) is expressed by a formula 8. In the formula 8, a row vector is expressed by x_{0, t}=(3, 3). The subspace specifying unit 35 calculates a difference between the manufacturing condition data x_{0, t+1} in the formula 7 and the manufacturing condition data x_{0, t} in the formula 8, and creates a difference vector in a formula 9. In the formula 9, a row vector is expressed by Δx₀=x_{0, t+1}−x_{0, t}=(2, 1).

FIG. 12(A) shows an example of the processing in step S12. The subspace specifying unit 35 creates a vertical vector in which the difference vectors {Δx₁, Δx₂, Δx₀} in FIG. 11 are connected in a vertical direction. The vertical vector is defined as V. The vertical vector V is expressed by a formula 10. The vertical vector V in the formula 10 is expressed by row vectors (2, 1, 2, 1, 2, 1).

FIG. 12(B) shows an example of the processing in step S13. The subspace specifying unit 35 expresses the vertical vector V in FIG. 12(A) by a sum of vectors for data items of the manufacturing condition data. A vector of the first data item is defined as V1 and a vector of the second data item is defined as V2. A formula 11 is expressed by V=V1+V2. In the formula 11, V1 is expressed by row vectors (2, 0, 2, 0, 2, 0) and V2 is expressed by row vectors (0, 1, 0, 1, 0, 1).

FIG. 13 shows an example of the processing in step S14. In the vector sum (V=V1+V2) in FIG. 13 (B), the subspace specifying unit 35 calculates a coefficient value so as to set each component to 1. Coefficients are defined as c1 and c2. The coefficients are expressed in a formula 12. In the formula 12, row vectors are expressed by V=V1+V2=c1×(1, 0, 1, 0, 1, 0)+c2×(0, 1, 0, 1, 0, 1). Coefficient values obtained from the formula 12 are, for example, (c1, c2)=(2, 1). As shown in a formula 13, the subspace specifying unit 35 sets the obtained coefficient values as subspace data as a matrix of two rows and one column, in other words, a column vector with the number of dimensions of 2. The subspace data in the formula 13 is expressed by row vectors (a1, a2). The subspace data is data obtained by projecting the manufacturing condition data so as to reduce the number of dimensions. The number of dimensions of the subspace data is reduced to 2 with respect to the number of dimensions of an original vector of 6.

The manufacturing condition specifying unit 36 in step S8 of FIG. 4 executes the processing of specifying the manufacturing condition data D11 at the next time point based on the third learning model LM3 by using the subspace manufacturing condition data D10 whose number of dimensions is reduced as an input. Since the number of dimensions of the input data is reduced by the subspace conversion processing, the processing in S8 can be executed efficiently in a short time compared to a case where the subspace conversion processing is not executed. That is, the manufacturing condition specifying system according to the embodiment can specify an optimal partial condition in a short time. Since the optimal partial condition can be immediately reflected in a manufacturing flow, a product yield can be improved in a short period even after a manufacturing state change.

### [Manufacturing State Change]

An example of a manufacturing state change will be described as follows. A worker may perform a maintenance operation on a manufacturing device or the like of each manufacturing process that forms the manufacturing flow of the manufacturing system. In this case, before and after a maintenance event (corresponding event time point), an internal or an external physical state of the manufacturing device or the like, for example, a value of a parameter such as a current may change instead of being a constant value. Depending on the manufacturing state change, an optimal manufacturing condition may be changed. When an operation is executed by continuing to apply the same manufacturing condition before and after the manufacturing state change, the quality of a product to be manufactured after the change may be deteriorated. That is, depending on the manufacturing state change, a suitable manufacturing condition may be changed internally, and it is necessary to specify a suitable manufacturing condition after the change. Therefore, corresponding to such a manufacturing state change, the manufacturing condition specifying system according to the embodiment has a function of building a model and a learning model and specifying a suitable or optimal manufacturing condition corresponding to a next time point after the change.

It should be noted that a unit of time point and time used in the manufacturing condition specifying system according to the embodiment is of a unit with a size corresponding to manufacturing time of a product in a target manufacturing system, for example, a day, an hour, a minute and the like, and can be set appropriately.

Parameters that form the manufacturing condition data correspond to a manufacturing flow of the target manufacturing system, can be set appropriately, and are not particularly limited. Examples of the parameters include currents, voltage, temperature, pressure, and the like. These parameters can be controlled, measured or the like. For example, the parameters include a current or voltage at a predetermined position in a manufacturing device, pressure in a predetermined space in a manufacturing device, temperature of an environment near the inside or outside of a manufacturing device, and the like. Examples of an applicable target manufacturing system and manufacturing flow include, but not limited to, at least a semiconductor manufacturing system and manufacturing flow.

### [Display Screen]

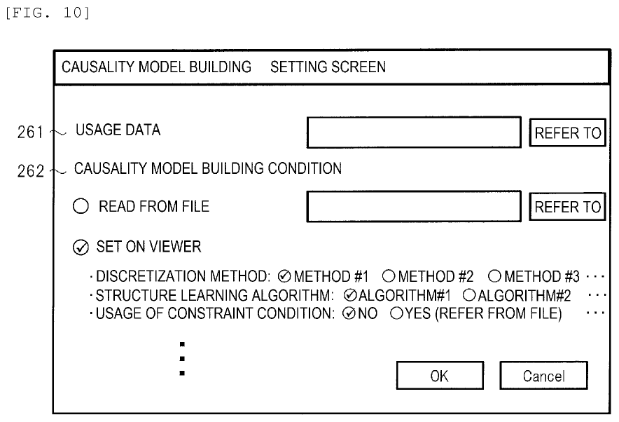

FIGS. 6 to 10 show examples of main screens to be displayed on the display screen of the display device by the display unit 20 in the computer 1 in the manufacturing condition specifying system. Examples of the screens include the model building screen in FIG. 6, a manufacturing condition screen in FIG. 7, a quality screen in FIG. 8, the result screen in FIG. 9, a model building setting screen in FIG. 10, and the like.

### [Model Building Screen]

The model building screen in FIG. 6 includes one or more model display regions 210 for displaying information of the models 50. In an example of FIG. 6, three model display regions 210 corresponding to three models among the plurality of (N) models are shown. The model display area 210 is an area where a configuration of a model obtained by the model building unit 31 is graphically displayed by the model display unit 21. The model display area 210 includes an area 213, a setting button 211, a build button 212, and a label 214. One model is displayed in the area 213. Number, name, and the like are displayed as a label for each model in the label 214.

In the example of FIG. 6, a network structure of a causality model is displayed as an example of a model in the area 213. In the area 213, the causality model is represented by a plurality of nodes and edges. Each node corresponds to manufacturing condition data. Each node is displayed with a node ID (corresponding manufacturing condition data ID) or the like. When an entire model cannot be displayed on the screen, a part of the model can be displayed using a scroll bar or the like, and a display portion can be changed according to a user operation. For example, the Model #1 includes 305 pieces of data with IDs from X1 to X304 and Y as a plurality of nodes. The last data with the ID of Y represents the quality data.

### [Model Building Setting Screen]

When the user presses the setting button 211 on the model building screen in FIG. 6, the model building setting screen in FIG. 10 is displayed in a pop-up way or the like. The model building setting screen in FIG. 10 shows an example of a screen for the user to input and set information related to the building of the models 50. Although the example of the screen is an example of a screen in a case where a causality model is used, when a model of another form is used, a setting screen corresponding to the form is provided. The screen includes a usage data setting field 261 and a causality model building condition setting field 262. In the setting field 261, manufacturing condition data which is data to be used at the time of building the causality model (for example, data to be monitored from a manufacturing flow) can be set by using, for example, a method of referring to a file. In the setting field 262, a condition to be used at the time of building the causality model can be set by using a method of referring to a condition setting file or a method of setting while checking on a viewer (another setting screen). In the method of setting on a viewer, it is possible to set by using a method of selecting from options of a discretization method, a structure learning algorithm, the presence or absence of usage of a constraint condition which are generally used in a case of the causality model. A known technique can be used for these methods.

After setting a condition or the like, the user presses an OK button. Accordingly, the control unit 30 reflects the condition or the like in the manufacturing condition specifying system. Then, according to the processing of the model building unit 31, the causality model can be built under the condition or the like. When the user presses a Cancel button, the condition or the like is not reflected, and the screen returns to a state before the setting screen is opened (the screen in FIG. 6).

The model display unit 21 includes one or more model display areas 210 for displaying one or more causality models built by the model building unit 31, and displays the model display areas 210 in the model building screen in FIG. 6. When a plurality of models are built, the model display unit 21 allocates a label 214 to each model and displays the label 214. The label 214 is associated with a model ID of data in the storage unit 40.

### [Manufacturing Condition Screen]

The manufacturing condition screen in FIG. 7 includes a manufacturing condition display area 220 and a subspace display area 230. The manufacturing condition display area 220 is an area for displaying the acquired manufacturing condition data that is stored in the manufacturing condition data storage unit 41. The manufacturing condition display area 220 is in, for example, a table format, and includes a time point and a plurality of manufacturing condition data as item columns. The “time point” item corresponds to a time point T which is an acquisition time point, and values are stored in time-series order. For example, the latest acquisition time point is defined as a time point Tn. In a manufacturing condition data item 221, data items of a plurality of manufacturing condition data are displayed. Here, the number of manufacturing condition data is defined as m, and m=304 is shown is shown as an example.

The subspace display area 230 is an area where the subspace display unit 23 displays the subspace data obtained by the subspace specifying unit 35. A time difference (that is, a difference vector) of each model of the manufacturing condition data is displayed as the subspace data in the subspace display area 230. The subspace data related to the manufacturing condition data X1 is shown in the example. The subspace display area 230 is in, for example, a table format, and includes a model ID and a plurality of time periods as item columns. The model ID is an ID for each model, and corresponds to a label. The plurality of time periods are time periods between the time points T. For example, for the manufacturing condition data X1, and Model #1, a difference between data item values is 2 during a time period from a time point T1 to a time point T2, and a difference between data item values is 0 during a time period from the time point T2 to a time point T3.

### [Quality Screen]

The quality screen in FIG. 8 includes a product yield display area 240. The product yield display area 240 is an area for displaying graph data in which quality data stored in the quality data storage unit 42 is converted into a product yield and arranged in time-series order. A product yield display unit 24 forms a graph of the product yield and displays the graph in the product yield display area 240.

In the product yield display area 240, it is also possible to display an event time point 242 which is data representing a time point when an event is generated in a manufacturing process of a manufacturing flow. The event includes an event such as maintenance corresponding to a manufacturing state change. For example, an event time point Tx indicates a time point when a maintenance event occurs in a certain manufacturing device Dx.

As shown in the quality screen, the product quality varies over time. In the example, the yield tends to decrease at approaching time points before and after a certain event time 242 (Tx). Thereafter, a suitable manufacturing condition is specified by the manufacturing condition specifying system according to the embodiment, and when the suitable manufacturing condition is applied to the manufacturing flow, the yield tends to increase and is improved.

### [Result Screen]

The result screen in FIG. 9 includes a manufacturing condition specifying display area 250. The manufacturing condition specifying display area 250 is an area for displaying optimal manufacturing condition data at the next time point specified by the manufacturing condition specifying unit 36, and a model corresponding to the optimal manufacturing condition data. The manufacturing condition specifying display unit 25 displays, in the area 251, the optimal manufacturing condition data at the next time point in, for example, a table format. The manufacturing condition specifying display unit 25 displays, in an area 252, a model selected from the models 50 corresponding to the optimal manufacturing condition data at the next time point in a format, for example, similar to the format of the model display area 210 in FIG. 6.

### [Manufacturing Condition Data]

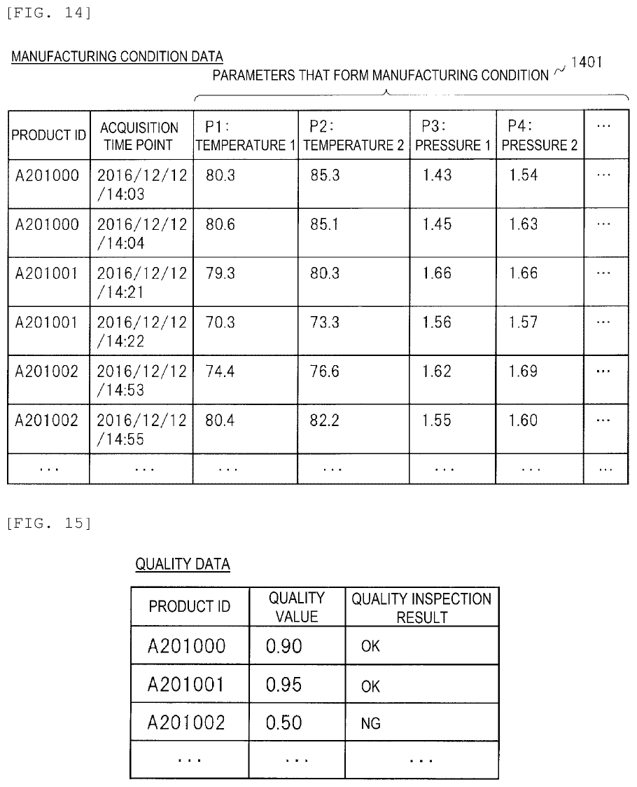

FIG. 14 shows a table of an example of a configuration of the manufacturing condition data stored in the manufacturing condition data storage unit 41. The table in FIG. 14 includes a product ID, an acquisition time point, and a plurality of parameters 1401 as item columns corresponding to header information. The plurality of parameters 1401 are a plurality of data items that forma manufacturing condition, and include P1 “temperature 1”, P2 “temperature 2”, P3 “pressure 1”, and P4 “pressure 2” as examples of parameters. The “product ID” is an identifier for each product manufactured in the manufacturing process. The “acquisition time point” is a time point when the computer 1 acquires the manufacturing condition data.

In the table of the manufacturing condition data as shown in FIG. 14, information of the event time point of the manufacturing condition change may be stored, or information for identifying the manufacturing state change for each data item of the manufacturing condition data may be stored.

### [Quality Data]

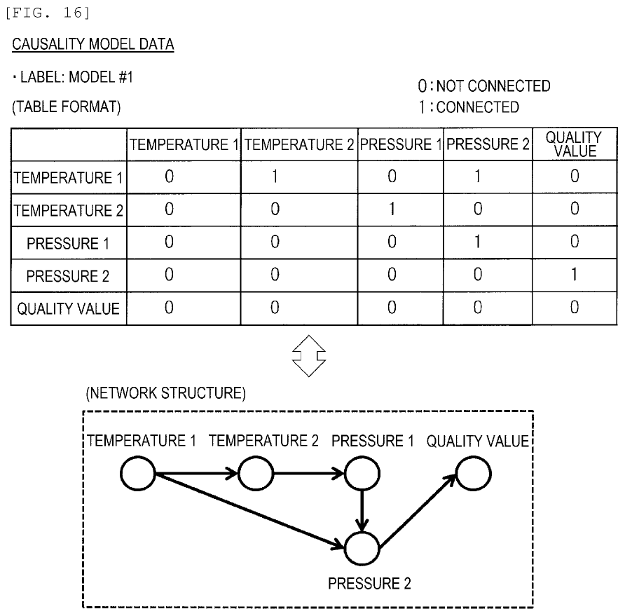

FIG. 15 shows a table of an example of a configuration of the quality data stored in the quality data storage unit 42. The table in FIG. 15 includes a product ID, a quality value, and a quality inspection result as item columns. The “quality value” is a value indicating quality of a product obtained in the quality inspection process (FIG. 2), and an example of the quality value is the product yield. The “quality inspection result” is a value obtained as a result of a predetermined determination in the quality inspection process based on the “quality value”. The determination is, for example, a comparison determination with a threshold. For example, when the quality value satisfies a target value (for example, a threshold of 0.90 or more), the value of the quality inspection result is “OK”, and when the quality value does not satisfy the target value, the value of the quality inspection result is “NG”.

### [Model Data]

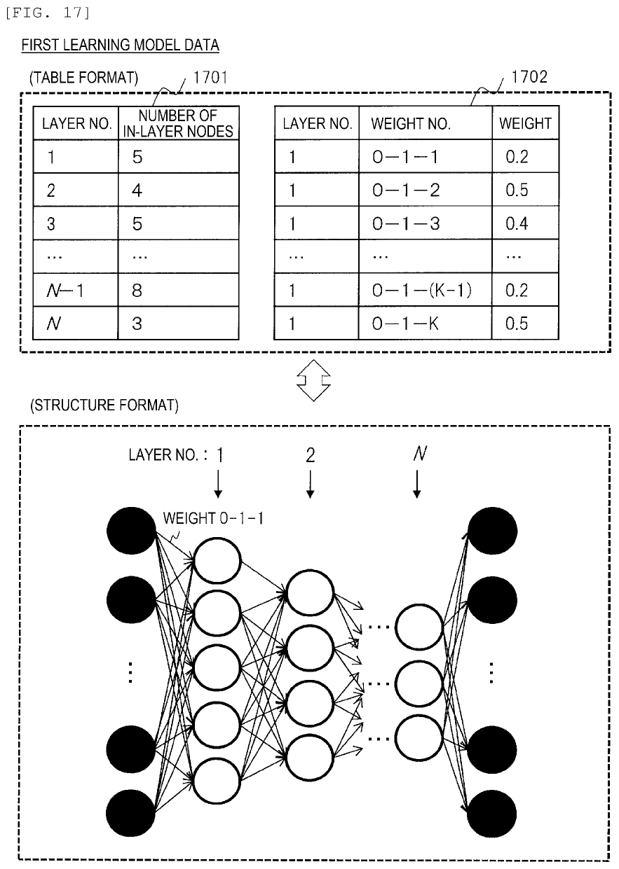

FIG. 16 shows an example of a configuration of data of the models 50 stored in the model storage unit 43. A causality model is shown as an example of a model. As shown on an upper side of FIG. 16, the causality model can be shown in a table format. Parameters (“temperature 1” and the like in FIG. 14, and quality values of the quality data) corresponding to each node of the manufacturing condition data are arranged in the rows and columns of the table. A value indicating causality (a connection relationship by an edge) between a node of a row and a node of a column is stored in a cell portion where the row and the column intersect. The value is a binary value. When nodes are not connected (that is, there is no causality), the value is set to “0”, and when nodes are connected (that is, there is causality, and there is an edge), the value is set to “1”.

A lower side of FIG. 16 shows a case where the table on the upper side is expressed as a network structure. Data in the table on the upper side is stored in the model storage unit 43. At the time of displaying the data on a screen, a network structure can be formed by converting from the table. The model data shown in FIG. 16 is presented in each model building of the manufacturing state change in step S2, each model is allocated with a label or an ID for identification, and the label or ID are stored as part of the model data.

### [First Learning Model]

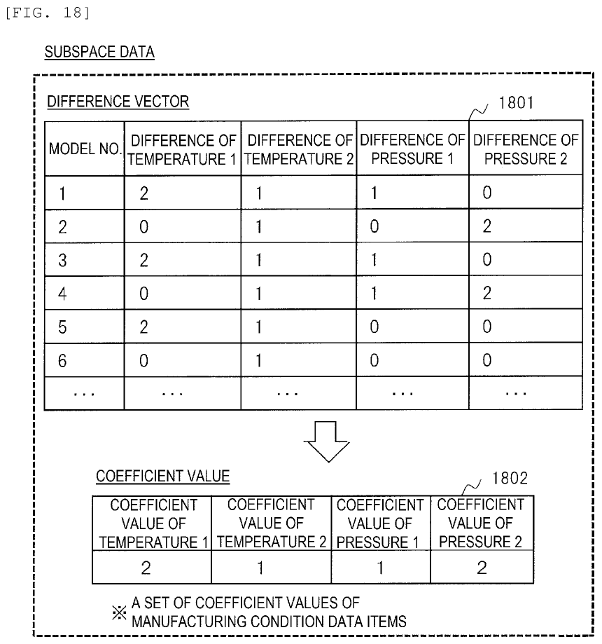

FIG. 17 shows an example of a configuration of first learning model data stored in the first learning model storage unit 44. The example shows a case where a deep learning model is used as an example of a reinforcement learning model which is the first learning model. As shown on an upper side, the first learning model data can be shown in a table format. The table includes a table 1701 on a left side and a table 1702 on a right side. The table 1701 on the left side includes a layer number and the number of in-layer nodes as item columns. The “layer number” is a number for identifying a layer. The “the number of in-layer nodes” indicates the number of nodes in a layer. The table 1702 on the right side includes a layer number, a weight number, and a weight as item columns. The “weight number” is a number for identifying a “weight” held in each layer. The “weight” indicates a numerical value of a weight that is given to an edge between nodes. Such data in the table is stored in the first learning model storage unit 44. A lower side of FIG. 17 shows a case where the table in the upper side is expressed in a network structure format. The number N of layers shown in FIG. 17 is different from the above-described number N of models. A configuration of second learning model data is similar to the configuration of the first learning model data.

### [Subspace Data]

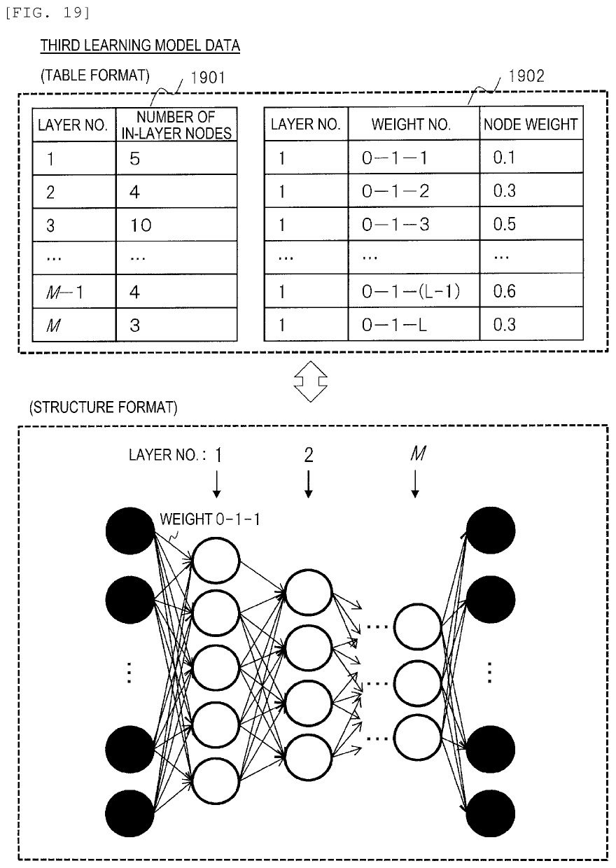

FIG. 18 shows a table of an example of a configuration of the subspace data stored in the subspace storage unit 45. A table 1801 on an upper side of FIG. 18 is a table showing difference vectors (step S11 in FIG. 5, for example, FIG. 11) calculated in the processing of the subspace specifying unit 35. The table 1801 includes a model number and a difference for each data item (parameter such as “temperature 1”) of the manufacturing condition data as item columns. The model number is a number corresponding to a label or an ID for identifying each model of the plurality of (N) models 50. A difference vector for each mode is stored in each row of the table. The table 1801 includes the number of dimensions and a data volume according to a product between the number N of models and the number of data items.

A table 1802 on a lower side of FIG. 18 is a table showing an example of a configuration of data of a coefficient value (step S14 in FIG. 5, for example, FIG. 13) calculated in the processing of the subspace specifying unit 35. The data is a set of coefficient values of the manufacturing condition data items, and corresponds to the subspace data. The table 1802 includes a coefficient value for each data item (parameter such as “temperature 1”) of the manufacturing condition data as item columns. The number of dimensions and the data volume are reduced in the table 1802 than in the table 1801.

As described above, the subspace specifying unit 35 processes data of the difference vectors shown in the table 1801 on the upper side, calculates the coefficient values shown in the table 1802 on the lower side, and stores the subspace data which is the calculated coefficient values in the subspace storage unit 46.

### [Third Learning Model]

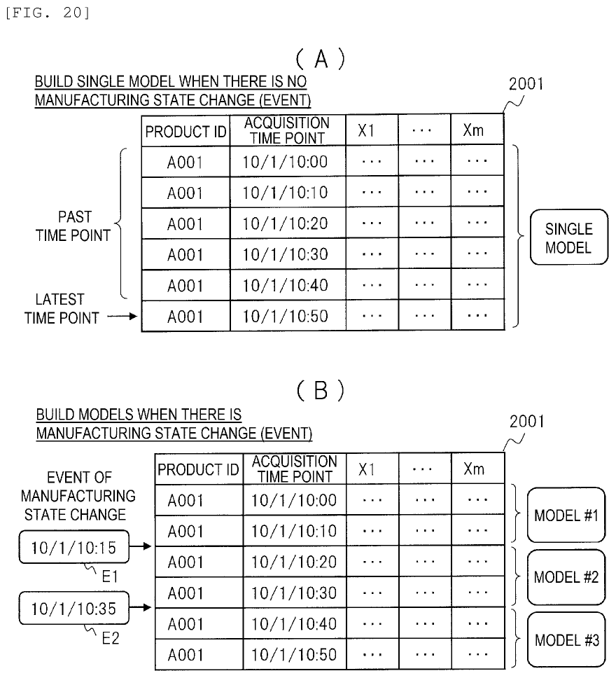

FIG. 19 shows an example of a configuration of third learning model data stored in the third learning model storage unit 47. A case where a deep learning model is used in a similar manner is shown as an example of a reinforcement learning model which is the third learning model. Similar to the example of the configuration of the first learning model data in FIG. 17, the example of the configuration of the third learning model data can be shown by a table or a network structure. The number of layers is different in each learning model. The table on an upper side of FIG. 19 includes a table 1901 on a left side and a table 1902 on a right side. Data in the tables on the upper side is stored in the third learning model storage unit 47.

### [Example of Model Building According to Manufacturing State Change]

FIG. 20 shows, as a supplement, a schema or an example when the models 50 are built based on the manufacturing condition data according to the manufacturing state change. FIG. 20(A) shows building of a single model when there is no event of the manufacturing state change. A table 2001 shows an example of the manufacturing condition data. As shown in the table 2001, for example, the “acquisition time” in each row is used as manufacturing condition data related to a product with a “product ID” of A001. Data is acquired at the latest time point, for example, the “acquisition time” is “10/1/10: 50” (10: 15, October 1). At this time, a single causality model is built using the data at the latest time point and data at a plurality of (for example, the number is set to, for example, 1000 or less) past time points. Although the “acquisition time” is the time point when the computer 1 acquires the manufacturing condition data, in contrast, in the manufacturing flow, information such as a time point when manufacturing in a manufacturing process is executed may be included, such information may be used.

FIG. 20(B) shows building of a plurality of models when there is an event of a manufacturing state change. Content of data in the table 2001 is the same. A manufacturing flow of a manufacturing system also includes data at a time point of an event in which the manufacturing state change occurs. The computer 1 can also acquire data at the time point of the event from the manufacturing system. As a time point of an event of the manufacturing state change, for example, an event E1 is at a time point “10/1/10: 15” and an event E2 is at a time point “10/1/10: 35”. The event E1 at the time point “10: 15” occurs between a time point (10: 10) in the second row and a time point (10: 20) in the third row. The event E2 at the time point “10: 35” occurs between a time point (10: 30) in the fourth row and a time point (10: 40) in the fifth row. The model building unit 31 divides data at the time points of events, and builds a model for each time period obtained by dividing. For example, a model #1 is built using a plurality of data including the data in the first row and the second row. A model #2 is built using a plurality of data including the data in the third row and the fourth row. A model #3 is built using a plurality of data including the data in the fifth row and the sixth row. It should be noted that the number of rows of the manufacturing condition data for building one model is not limited to two.

### [Learning Model]

Learning methods that can be applied to each of the above-mentioned learning models are as follows.

First learning model LM1: state space model, reinforcement learning model

Second learning model LM2: state space model, reinforcement learning model

Third learning model LM3: reinforcement learning model

Known reinforcement learning is a kind of machine learning that addresses a problem in which a current state of an agent in certain environment is observed and then an action to be taken is determined. The reinforcement learning learns a strategy to obtain the largest reward through a series of actions. A known deep learning model or the like can be applied as a reinforcement learning model. A known state space model is a kind of a time-series analysis model. The state space model includes a state model and an observation model.

### [Effects]

As described above, according to the manufacturing condition specifying system in the embodiment, even when there is a manufacturing state change, a suitable manufacturing condition can be specified, and the product quality can be maintained or improved. In particular, according to the embodiment, an optimal manufacturing condition corresponding to a quality target value can be specified according to the manufacturing state change. According to the embodiment, even when the number of operation data is small immediately after the manufacturing state change, a suitable manufacturing condition can be specified in a short period. In particular, according to the embodiment, a countermeasure can be easily made and a suitable manufacturing condition can be specified even when there is a large number of manufacturing state changes or a large number of parameters of a manufacturing condition and a model by using a subspace conversion. According to the embodiment or a modification, it is possible to improve the quality at an early stage after the manufacturing state change or improve a prediction accuracy of the model according to a priority policy.

As described above, the manufacturing condition specifying system according to the embodiment builds a plurality of models based on manufacturing condition data acquired at each state or time point of a past manufacturing state change. The system estimates a manufacturing condition at a next time point from each model of the plurality of models. The system calculates a difference for each time period between the time points from the plurality of estimated manufacturing conditions, and embeds the differences into a subspace as a base. The system uses subspace data which is the data embedded in the subspace as an input, and specifies an optimal manufacturing condition at a next time point based on learning.

Another embodiment can be implemented as follows. First, as a manufacturing condition specifying system according to a modification, the subspace conversion processing in step S7 in FIG. 3 may be omitted. In this case, in the manufacturing condition specifying processing in step S8, data of results of steps S4, S5, and S6 is input. The modification is also effective when the number of the manufacturing state change is small, or when the number of parameters of the manufacturing condition and the model is relatively small.

In the manufacturing condition specifying system according to the modification, with regard to the subspace conversion processing in step S7 in FIG. 4, only the first data of a result of step S4 may be used as the manufacturing condition data which is input data. Both the first data of the result of step S4 and the second data of a result of step S6 are used in step S7 in the above-described embodiment. The second data of the result of step S6 is the manufacturing condition data D9 that is predicted by using the manufacturing condition data D4 at the latest current time point (t). In this case, the manufacturing condition data D11 at the next time point is specified with emphasis placed on the latest manufacturing data. Therefore, this modification is effective in a case of a policy that places emphasis on improving, in an early stage, the product quality immediately after the manufacturing state change.

On the other hand, in the modification, the second data of the result of step S6 is not used during the processing of steps S7 and S8. The modification is effective in a case of a policy that places emphasis on increasing the prediction accuracy of the model more than improving, in an early stage, the product quality immediately after the manufacturing state change. In the modification, after the manufacturing state change, learning in a certain time period is advanced to increase the prediction accuracy of the model, and then optimal manufacturing condition data can be specified with high accuracy.

### Comparative Embodiment

When a system of a related-art example is used as a comparative example with respect to the manufacturing condition specifying system according to the embodiment, the difference or the like is as follows. In PTL 1, a probability model is built from past manufacturing conditions in order to specify a manufacturing condition under which a product is good, and a manufacturing condition that matches a target value is calculated. However, when there is a manufacturing state change that cannot be expressed by the past manufacturing conditions, it is necessary to correct a built model in this technique.

In PTL 2, prediction is executed by outputting a plurality of predicted values from past performance data (for example, manufacturing conditions or quality) and weighting the output values according to similarity. However, a manufacturing condition cannot be specified when a prediction target (here, quality) is a good product in this technique.

PTL 3 explores a condition (for example, a manufacturing condition) that satisfies a certain condition (for example, a condition under which a product is good) in an environment (for example, a manufacturing process) by using reinforcement learning. However, when there are a plurality of models to be used, the number of items of the manufacturing condition to be specified is reduced by class classification in this technique. Therefore, it is regarded that the manufacturing condition under which a product is good may not be obtained in this technique.

On the other hand, the manufacturing condition specifying system according to the embodiment can build a plurality of models using a manufacturing condition and quality obtained from past manufacturing including a manufacturing state change, and can explore an optimal manufacturing condition using a manufacturing condition and a quality error obtained from each model.

Although the invention has been described in detail based on the embodiment, the invention is not limited to the embodiment described above, and various modifications can be made without departing from the scope of the invention.

### REFERENCE SIGN LIST

1 computer
30 control unit
31 model building unit
32 model manufacturing condition specifying unit
33 quality specifying unit
34 manufacturing condition determining unit
35 subspace specifying unit
36 manufacturing condition specifying unit

1. A manufacturing condition specifying system, comprising:
a computer that specifies a manufacturing condition in each manufacturing process of a manufacturing flow, wherein
the computer:
uses manufacturing condition data and quality data at a plurality of time points including a current time point from the manufacturing flow to build a model related to the manufacturing condition and quality;
at a time of building the model, builds models each being built for a manufacturing state change as a plurality of models in a case of including manufacturing state changes in the manufacturing process of the manufacturing flow;
uses the model and a quality target value to calculate, in the model, a predicted value of manufacturing condition data at a next time point as first data based on learning in a first learning model;
uses the model as well as the manufacturing condition data and quality data at the current time point to predict quality data at a next time point and calculate a quality error between the quality data at the next time point and the quality data at the current time point;
uses the first data and the quality error to specify manufacturing condition data at the next time point based on learning in a learning model; and
stores and outputs information including the specified manufacturing condition data at the next time point.

2. The manufacturing condition specifying system according to claim 1, wherein
the computer:
uses the manufacturing condition data at the current time point to calculate a predicted value of manufacturing condition data at a next time point as second data based on learning in a second learning model, and
uses the first data, the second data, and the quality error to specify the manufacturing condition data at the next time point based on the learning in the learning model.

3. The manufacturing condition specifying system according to claim 1, wherein
the computer:
converts the first data into subspace data to reduce the number of dimensions, and
uses the subspace data and the quality error to specify the manufacturing condition data at the next time point based on the learning in the learning model.

4. The manufacturing condition specifying system according to claim 1, wherein
the computer divides the manufacturing condition data at the plurality of time points into data of a plurality of periods according to time points when a predetermined event occurs in the manufacturing process as the manufacturing state changes, and builds the respective models for the data of periods obtained by dividing.

5. The manufacturing condition specifying system according to claim 4, wherein
the event includes a maintenance operation on a manufacturing device in each manufacturing process.

6. The manufacturing condition specifying system according to claim 1, wherein
the model includes a causality model.

7. The manufacturing condition specifying system according to claim 1, wherein
the first learning model includes a state space model or a reinforcement learning model.

8. The manufacturing condition specifying system according to claim 2, wherein
the second learning model includes a state space model or a reinforcement learning model.

9. The manufacturing condition specifying system according to claim 1, wherein
the learning model includes a reinforcement learning model.

10. The manufacturing condition specifying system according to claim 1, wherein
the computer displays each of the models on a display screen of a display device.

11. The manufacturing condition specifying system according to claim 1, wherein
the computer displays, on a display screen of a display device, the manufacturing condition data at the plurality of time points and the subspace data.

12. The manufacturing condition specifying system according to claim 1, wherein
the computer displays, on a display screen of a display device, the quality data at the plurality of time points and a time point when a predetermined event occurs in the manufacturing process as the manufacturing state change.

13. The manufacturing condition specifying system according to claim 1, wherein
the computer displays, on a display screen of a display device, the specified manufacturing condition data at the next time point, and a model selected among the respective models and associated with the specified manufacturing condition data at the next time point.

14. The manufacturing condition specifying system according to claim 1, wherein
the computer:
acquires the manufacturing condition data and the quality data at a plurality of time points including the current time point from the manufacturing flow, and
transmits the specified manufacturing condition data at the next time point to a manufacturing system that controls the manufacturing flow and set the specified manufacturing condition data at the next time point in each of the manufacturing processes.

15. A manufacturing condition specifying method in a manufacturing condition specifying system which includes a computer that specifies a manufacturing condition in each manufacturing process of a manufacturing flow, the method comprising:
a step of using manufacturing condition data and quality data at a plurality of time points including a current time point from the manufacturing flow to build a model related to the manufacturing condition and quality, and at a time of building the model, building models each being built for a manufacturing state change as a plurality of models in a case of including manufacturing state changes in the manufacturing process of the manufacturing flow;
a step of using the model and a quality target value to calculate, in the model, a predicted value of manufacturing condition data at a next time point as first data based on learning in a first learning model;
a step of using the model as well as the manufacturing condition data and quality data at the current time point to predict quality data at a next time point and calculate a quality error between the quality data at the next time point and the quality data at the current time point;
a step of using the first data and the quality error to specify manufacturing condition data at the next time point based on learning in a learning model; and
a step of storing and outputting information including the specified manufacturing condition data at the next time point,
wherein the steps are to be executed by the computer.
